(19) United States
(12) Patent Application Publication
(10) Pub. No.: US 2016/0376711 A1
(43) Pub. Date: Dec. 29, 2016

(54) SYNERGISTICALLY ACTIVE MIXTURE FOR USE AS AN OXYGEN BINDER AND AS A CORROSION INHIBITOR IN AQUEOUS SYSTEMS

(71) Applicant: KURITA WATER INDUSTRIES LTD., Tokyo (JP)

(72) Inventors: Andre DE BACHE, Muehlheim (DE); Wolfgang HATER, Kaarst (DE)

(21) Appl. No.: 14/903,465

(22) PCT Filed: Jul. 30, 2014
(86) PCT No.: PCT/EP2014/002086

§ 371 Date: Jan. 7, 2016

(30) Foreign Application Priority Data
Aug. 7, 2013 (DE) 10 2013 013 121.9

(51) Int. Cl. C23F 11/14; C02F 1/68

(52) U.S. Cl. CPC C23F 11/142; C02F 1/683; C02F 2303/08

(57) ABSTRACT

The invention relates to a synergistically active mixture consisting of two components a and b, namely and alkyl hydroxylamine component and an aryl phenol component, for use as oxygen binders in steam generators and boilers. The mixture according to the invention simultaneously acts as a corrosion inhibitor by means of the oxygen binding.

The present invention relates to a synergistically acting mixture for use as oxygen binder in steam generators, boilers, closed cooling systems, district heating systems or heating circuits. Due to the oxygen binding effect, the mixture simultaneously acts as corrosion inhibitor.

In industrial steam generators and boilers, closed cooling systems, district heating systems or heating circuits in which metals come into contact with water, there is a risk of corrosion. The corrosion is caused by the oxygen dissolved in water. This oxygen therefore has to be removed, either by mechanophysical methods or by chemical treatment of the oxygen. It is also possible to combine the two methods by combining the physical method simultaneously with the chemical methods.

A known method is, for example, a combination of thermal degassing and introduction of oxygen binders such as the known hydrazine or sodium sulfite.

Sodium sulfite, for example, is a compound which has low volatility and whose reaction products contribute, in combination with oxygen, to increasing the conductivity of the boiler water and thus it causes concentration, especially in plants which are operated using deionized water. Use has therefore been made of hydrazine because the reaction products do not react with oxygen to increase the conductivity of the boiler water.

However, hydrazine is, like the frequently used compounds such as hydroquinone or methyl ethyl ketoxime, problematical with regard to occupational hygiene because they are toxic and carcinogenic. To replace hydrazine or ketoximes, some alternatives have been proposed over time:

Although U.S. Pat. No. 3,983,048 describes the use of the compound hydrazine, arylamines are also used in catalytic amounts in addition to hydrazine there. According to column 2, ortho- or para-phenylenediamines are used as arylamines. According to Table 1, the oxygen removal after 10 minutes is merely 95% when para-phenylene-diamine is used. However, the toxicological concerns were not able to be overcome completely by reducing the amount of hydrazine.

In U.S. Pat. No. 4,728,497, hydrazine was replaced completely by aminophenols. As a class of compounds, they are less toxic and in addition have a greater oxygen binding capacity. These compounds include, for example, 2,4-diaminophenol, 5-methyl-o-aminophenol, o- or p-amino-phenol and salts thereof, etc. It can be seen from Table 1 of this document that although the aminophenols are more effective than hydrazine, viz. they can remove oxygen to an extent of up to 99% under comparable conditions, but on the other hand their reaction rate is relatively slow.

U.S. Pat. No. 4,067,960 has proposed N,N-diethylhydroxylamine or salts thereof as alternative oxygen binders instead of hydrazine having a low hazard potential. Thus, for example, compared to, inter alia, hydrazine or sodium sulfite, an improvement in the reduction of the dissolved oxygen from 96.8 to 98% was achieved when using N,N-diethylhydroxylamine/DEHA/. However, hydroquinone, benzoquinone or metal salts had to be used as catalysts in order to increase the reaction rate. However, the use of these compounds is undesirable or disadvantageous because of their toxicity. The metal salts used as catalysts, e.g. copper or cobalt salts, were also disadvantageous since they cause contact corrosion or in the case of a few cobalt salts are carcinogenic.

Furthermore, attempts have been made in the prior art to improve DEHA in combination with other, less toxic catalysts, especially because DEHA has a relatively slow oxygen binding effect, and EP 1 619 272 A1 has proposed heterocyclic compounds containing N-substituted amino groups, for example 1-amino-4-methylpiperazine, 1-aminopyrrolidine. However, a catalyst based on phenols containing a plurality of hydroxyl groups also had to be added to DEHA and the two compounds mentioned.

Reduction of oxygen in a mixture consisting of DEHA, 1-aminopyrrolidone and pyrogallol as catalyst gives, in Table 4 of EP 1 619 272 A1, a residual oxygen concentration after 20 minutes of 0.3 mg/l.

Neither the combination of DEHA with heterocyclic compounds containing N-substituted amino groups nor the sole use of aminophenols has brought a satisfactory result under the temperature and pressure conditions prevailing in steam generators in industry and especially with regard to the requirement in respect of the speed of oxygen removal.

U.S. Pat. No. 4,626,411 discloses a mixture consisting of three components a, b and c, where component a is present in a ratio to component c of from 10:1 to 1:10 and component b is present in a ratio to component c of from 10:1 to 1:100, for removing oxygen and reducing corrosion in boilers. Component a is a hydroxylamine compound, component b is an aromatic compound, for example aminophenol, and component c is an amine which serves to set the pH.

In column 5, lines 8 ff., it is stated that only the combination of neutralizing amine and hydroquinone brings about a very surprising effect on the increase in the reaction rate of N,N-diethylhydroxylamine with the oxygen.

However, the use of hydroquinones or the metal catalysts were not indicated for environmental reasons and from a toxicological point of view.

It has surprisingly been found that the use of a combination of only 2 components, namely a hydroxylamine, e.g. N,N-diethylhydroxylamine, as component a with an arylphenol derivative, e.g. 4-aminophenol, as component b in a ratio of from 6:1 to 1:1.5 displays a synergistic action in the removal of oxygen and thus also in reducing corrosion under the conditions of industrial steam generators, contrary to expectations. Compared to the individual components, this combination displays a significantly improved reaction rate, i.e. an increased degree of binding of oxygen. The use of a third component, e.g. quinones or hydroquinones, could advantageously be dispensed with in this way.

The general structure or formula (I) of the hydroxylamines is:

HONR¹R² (I)

where the substituents R¹, R² can be identical or different and have the general formula CₙH₂ₙ₊₁, where n=1 to 5, preferably from 1 to 2.

The component a to be used according to the invention can be, for example, N,N-diethylhydroxylamine, which has the formula (II):

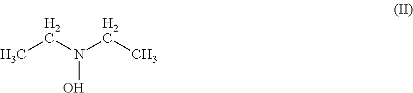

The arylphenols of the component b have the general structural formula (III):

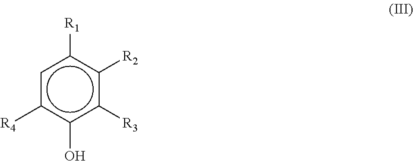

R₁, R₂, R₃ and R₄ are defined as follows:

R₁, R₂, R₃ and R₄ are each, independently of one another,

a) CₘH₂ₘ₊₁—N) (—R₅) (—R₆) or

b) OR₇ or

C) R₈

where at least one R₁, R₂, R₃ and R₄ is a CₘH₂ₘ₊₂—N(—R₅) (—R₆) group. Here, R₅, R₆, R₇, R₈ are each, independently of one another, CₙH₂ₙ₊₁ and n and m are integers from 0 to 4, preferably integers from 0 to 2.

Preferred arylphenol compounds according to the invention are:

4-aminophenol and 2-aminophenol

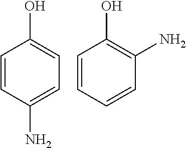

3-amino-4-methylphenol and 4-amino-3-methylphenol

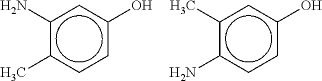

and 4-amino-2-(aminomethyl)phenol

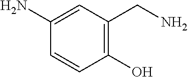

The components a and b are present in a weight ratio to one another of from 6:1 to 1:1.5, in particular in a ratio of from 5:1 to 1:1.

According to the invention, particular preference is given to the combination of N,N-diethylhydroxylamine (component a) and 4-amino-3-methylphenol (component b).

Measurement Method:

The measurement of the oxygen concentration was carried out using the Sensor InPro 6800 measurement instrument from METTLER TOLEDO.

Mettler Toledo InPro 6800 sensors are employed for the in-line measurement of the oxygen partial pressure in liquids and gases.

The O₂ sensors InPro 6800 with integrated temperature sensor are employed for determining oxygen.

Functional Principle

The InPro 6800 is based on the polarographic measurement of O₂ by the method of Clark, which can be summarized as follows:

The Clark sensor consists of a working electrode (cathode), counterelectrode/reference electrode (anode) and an oxygen-permeable membrane which separates the electrodes from the measurement medium.

A constant voltage is applied to the cathode via the transmitter in order to reduce the oxygen. The oxygen molecules diffuse from the measurement medium through the membrane to the electrodes and are reduced at the cathode to which the voltage is applied. At the same time, oxidation in which the anode metal (silver) is released as silver ions into the electrolyte takes place at the anode. This makes the electrolyte conductive and a current flows between anode and cathode (ion conductivity). The current generated is measured by the transmitter and is proportional to the oxygen partial pressure (pO₂) in the measurement medium.

Reaction at the cathode:

O₂+2H₂O+4e⁻→4OH

Reaction at the anode:

4Ag+4Cl⁻→4AgCl+4e⁻

### EXAMPLES ACCORDING TO THE INVENTION

The oxygen binder is introduced into a flask which is filled with deionized water (conductivity <1 μS/cm) and in which the supernatant amount of gas is minimal and the oxygen concentration is measured by means of the electrode after defined points in time. During the experiment, the solution was blanketed with purified nitrogen.

The measurements were carried out at a temperature of 45° C.

The relative synergistic effect RS of the mixture is derived from the measured oxygen reduction Δc_{g}[O₂] (t) and the calculated oxygen reduction Δc_{b}[O₂] (t) at the point in time t of the measurement, in accordance with:

RS=Δc_{g}[O₂](t)/Δc_{b}[O₂](t)−1.

If RS>0, a synergistic effect is present; if RS<0, an antagonistic effect is present.

The measured oxygen reduction Δc_{g}[O₂] (t) is given by the difference between the initial oxygen concentration c_{g}[O₂] (0) and the measured oxygen concentration at the respective point in time of the measurement c_{g}[O₂] (t):

Δc_{g}[O₂](t)=c_{g}[O₂](0)−c_{g}[O₂](t)

The initial oxygen concentration c_{g}[O₂] (0) was 7.1 mg/l.

The calculated oxygen reduction Δc_{b}[O₂] (t) is given by the weighted average of the measured oxygen reductions Δc_{g}[O₂](A,t) and Δc_{g}[O₂](B,t) of the two individual components a and b alone, in accordance with

Δc_{b}(t)=c(A)/60·Δc_{g}[O₂](A, t)+c(B)/60·Δc_{g}[O₂](B, t).

Here, c(A) and c(B) are the initial concentrations of the components a and b in the mixture.

### EXAMPLE 1

### Mixture of N,N-diethylhydroxylamine and 4-aminophenol

TABLE 1
measured oxygen concentration c_{g}[O₂]
for mixtures of DEHA and 4-aminophenol

| | | 4-Amino- | DEHA:4- | c_{g}[O₂] | c_{g}[O₂] | c_{g}[O₂] |
|---|---|---|---|---|---|---|
| | DEHA | phenol | amino- | (2 min) | (4 min) | (6 min) |
| | [mg/l] | [mg/l] | phenol | [mg/l] | [mg/l] | [mg/l] |
| c_{g}[O₂] | 60 | 0 | 1:0 | 7 | 6.7 | 6.4 |
| (A, t) | 50 | 10 | 5:1 | 6.2 | 4.8 | 5.3 |
| | 40 | 20 | 2:1 | 6.6 | 4.7 | 3.6 |
| | 30 | 30 | 1:1 | 6.3 | 3.8 | 2.4 |
| | 20 | 40 | 1:2 | 6.4 | 5.2 | 3.9 |
| | 10 | 50 | 1:5 | 6.1 | 3.7 | 2.6 |
| c_{g}[O₂] | 0 | 60 | 0:1 | 6 | 2.3 | 1.1 |
| (B, t) | | | | | | |

### EXAMPLE 2

### Mixture of N,N-diethylhydroxylamine and 4-amino-3-methylphenol

TABLE 2
Relative synergy RM for mixtures of DEHA and
4-aminophenol

| | | DEHA:4-amino- | | | |
|---|---|---|---|---|---|
| DEHA | 4-Aminophenol | phenol | RS | RS | RS |
| [mg/l] | [mg/l] | [mg/l] | (2 min) | (4 min) | (6 min) |
| 50 | 10 | 5:1 | 1.2 | 0.9 | 0.1 |
| 40 | 20 | 2:1 | 0.2 | 0.3 | 0.5 |
| 30 | 30 | 1:1 | 0.2 | 0.3 | 0.5 |
| 20 | 40 | 1:2 | −0.4 | −0.4 | −0.2 |
| 10 | 50 | 1:5 | −0.2 | −0.2 | −0.1 |

TABLE 3
measured oxygen concentration c_{g}[O₂] for mixtures of N,N-
diethylhydroxylamine (DEHA) and 4-amino-3-methylphenol

| | | 4-Amino- | DEHA:4- | c_{g}[O₂] | c_{g}[O₂] | c_{g}[O₂] |
|---|---|---|---|---|---|---|
| | | 3-methyl- | amino-3- | (5 | (10 | (15 |
| | DEHA | phenol | methyl- | min) | min) | min) |
| | [mg/l] | [mg/l] | phenol | [mg/l] | [mg/l] | [mg/l] |
| c_{g}[O₂] | 60 | 0 | 1:0 | 6.4 | 5.7 | 5.1 |
| (A, t) | 57.14 | 2.86 | 20:1 | 6.2 | 5.6 | 5.4 |
| | 56.25 | 3.75 | 15:1 | 6.5 | 5.8 | 5.5 |
| | 54.55 | 5.45 | 10:1 | 6.4 | 5.6 | 5.2 |
| | 50 | 10 | 5:1 | 6 | 3.9 | 2.8 |
| | 40 | 20 | 2:1 | 5.3 | 3.8 | 2.6 |
| | 30 | 30 | 1:1 | 5.4 | 3.2 | 1.6 |
| | 20 | 40 | 1:2 | 6 | 4.5 | 2.6 |
| | 10 | 50 | 1:5 | 5.8 | 3.8 | 2.3 |
| c_{g}[O₂] | 0 | 60 | 0:1 | 6.1 | 4.6 | 1.9 |
| (B, t) | | | | | | |

TABLE 4
Relative synergy RM for mixtures of N,N-diethylhydroxylamine
(DEHA) and 4-amino-3-methylphenol

| | 4-Amino-3- | | | | |
|---|---|---|---|---|---|
| | methyl- | DEHA:4- | | | |
| DEHA | phenol | amino-3- | RS | RS | RS |
| [mg/l] | [mg/l] | methylphenol | (5 min) | (10 min) | (15 min) |
| 57.14 | 2.86 | 20:1 | 0.1 | 0.0 | −0.2 |
| 56.25 | 3.75 | 15:1 | −0.2 | −0.2 | −0.2 |
| 54.55 | 5.45 | 10:1 | 0.0 | −0.1 | −0.2 |
| 50 | 10 | 5:1 | 0.2 | 0.9 | 0.6 |
| 40 | 20 | 2:1 | 1.3 | 0.8 | 0.4 |
| 30 | 30 | 1:1 | 1.0 | 0.9 | 0.5 |
| 20 | 40 | 1:2 | 0.3 | 0.2 | 0.0 |
| 10 | 50 | 1:5 | 0.5 | 0.5 | 0.1 |

A synergistic effect (RS>0) is apparent for both mixtures of component a (DEHA) and component b (4-aminophenol; 4-amino-3-methylphenol) in a ratio of from 5:1 to 1:1.

The mixture according to the invention is generally introduced into the boiler feed water, for example in an amount proportional to the boiler feed water by means of a metering pump. The metering of the mixture is usually set so that a minimum concentration of N,N-diethylhydroxylamine can be detected in the condensate and in the boiler water. Monitoring of the degree of success can be effected by measurement of the iron content or by inspection of the plant components.

1. A synergistic oxygen binder consisting of the components a and b in a ratio of from 6:1 to 1:1.5, preferably in a ratio of from 5:1 to 1:1, wherein component a is a dialkylhydroxylamine having the general formula (I)
HONR₂ (I)
and the substituents R can be identical or different, where R=CₙH₂ₙ₊₁, where n=1 to 5, preferably from 1 to 2,
component b is an arylphenol derivative of the formula (III) 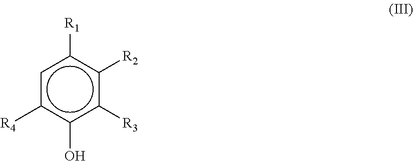
where R₁, R₂, R₃ and R₄ are each, independently of one another, a) CₘH₂ₘ₊₁—N(—R₅)(—R₆) or b) OR₇ or c) R₈, where at least one R₁, R₂, R₃ and R₄ is a CₘH₂ₘ₊₁—N(—R₅)(—R₆) group and R₅, R₆, R₇, R₈ each have, independently of one another, the formula CₙH₂ₙ₊₁ and m and n are integers from 0 to 4, preferably from 0 to 2.

2. The oxygen binder as claimed in claim 1, wherein the components a and b are present in a weight ratio in the range from 6:1 to 1:1.5, preferably in a ratio in the range from 5:1 to 1:1, in the water to be treated.

3. The oxygen binder as claimed in claim 1, wherein component a is preferably N,N-diethylhydroxylamine (DEHA).

4. The oxygen binder as claimed in claim 1, wherein R₁, R₂, R₃ and R₄ are each, independently of one another, a) CₘH₂ₙ₊₁—N(—R₅)(—R₆) or b) OR₇ or c) R₈, where at least one R₁, R₂, R₃ and R₄ is a —NH₂ group and R₅, R₆, R₇, R₈ are each, independently of one another, CₙH₂₊₁ and m and n are integers from 0 to 4, preferably from 0 to 2.

5. The oxygen binder as claimed in claim 4, wherein the arylphenol derivative is selected from among n-aminophenols where n=2,3,4, n-amino-m-CₒH₂ₒ₊₁-phenol or n-amino-m-CₒH₂ₒNH₂-phenol, where n=2,3,4 and m=2,3,4 and n is not equal to m and o is an integer from 1 to 4.

6. The oxygen binder as claimed in claim 6, characterized in that the component b is preferably 4-aminophenol or 2-aminophenol or 4-amino-3-methylphenol or 3-amino-4-methylphenol or 4-amino-2-(aminomethyl)phenol.

7. The use of the oxygen binders as claimed in claim 1 in industrial steam generators, boilers, closed cooling systems, district heating systems or heating circuits.
